(19) United States
(12) Patent Application Publication
(10) Pub. No.: US 2007/0212467 A1
(43) Pub. Date: Sep. 13, 2007

(54) Procedure to Manufacture a Texturized, Thermo-Resistant and Thermo-Irreversible Gel Composed of Vegetable and/or Animals Fats and the Product Made with this Procedure

(76) Inventors: Pierre La Haye, Montreal (CA); Marcel St-Jean, Lachenaie (CA); Michel Jolicoeur, Blainville (CA)

Correspondence Address: Invention Quebec Inc, 8065 Viau Blvd, Suite 202, Montreal Quebec, H1R 2T2, CA

(21) Appl. No.: 11/587,376

(22) PCT Filed: Apr. 25, 2005
(86) PCT No.: PCT/CA05/00631

§ 371 Date: Oct. 24, 2006

(30) Foreign Application Priority Data
Apr. 24, 2004 (GB) 0409156.7

(51) Int. Cl. A23L 1/05

(52) U.S. Cl. 426/573

(57) ABSTRACT

The Invention describes a manufacturing process, the resulting product and its usages: a thermo-resistant, thermo-irreversible gel made from vegetable and/or animal fat(s). An initial plastic emulsion is made by emulsifying Component A, characterized in being lipophilic and amphipathic (vegetable and/or animal fat(s) and oil(s) blended with solubilized milk proteins), with Component B, said to be hydrophilic (composed at minimum of water). Final texture is fixed by dissolving a salt into it. This gel is offered to solve the world problem facing food industries preparing and manufacturing more nutritious meals containing fats from various animal sources. This gel can be utilized as a complete or partial fat replacer in any human or animal food formulations. It is used especially where fat should remain visible or where textures (firmness or softness) should remain the same after cooking or freezing. The Invention may contain additives, drugs, medications and/or other complementary food ingredients.

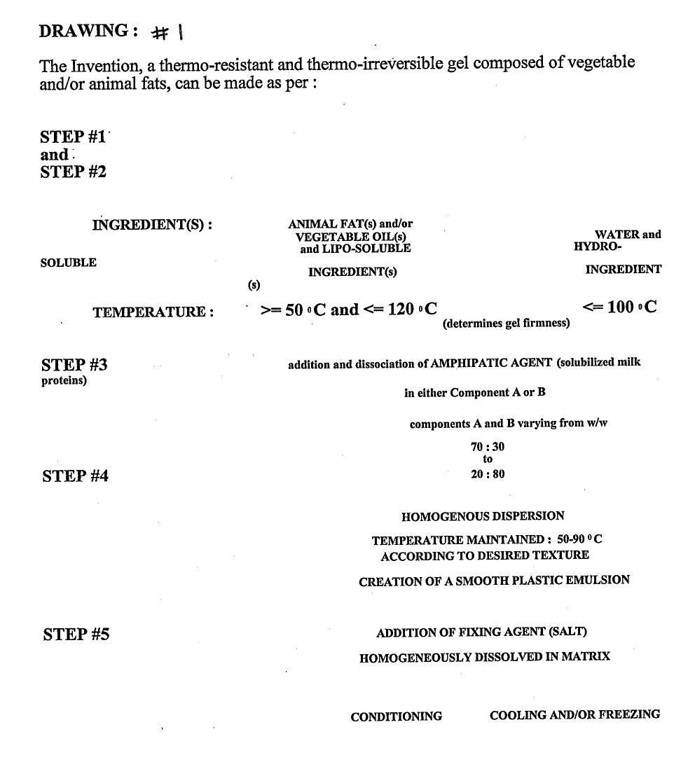

This application claims priority from UK Patent Application Serial Number 0409156.7 filed Apr. 24, 2004.

### FIELD OF INVENTION

This Invention relates to a manufacturing procedure of a texturized, thermo-resistant and thermo-irreversible gel composed of vegetable and/or animal fats made from a gross oil:water emulsion where solubilized caseinates with amphipathic properties are included and where the whole material is fixed and controlled by a proper ionic environment.

The Invention also relates to the gel itself and its applications as an animal and/or hydrogenated vegetable oil(s) replacer, total or partial, in the non-limiting fields of dairy, butchery, delicatessen, bread and pastry, cheese making, sauces, pet food, vegetarian foods and pharmaceuticals.

### BACKGROUND OF THE INVENTION

It is widely known in the food industry, especially in the processed butchery, that the addition of dairy proteins hydrolysates or whole natural milk proteins in processed meats like hamburger patties or fresh sausages creates an internal but non-controlled gel upon cooking of the product. This gel links together the meat particles in a matrix of formless aggregates. This manufacturing process is used as a simple meat texturizer when cost allows it. Unfortunately this manufacturing method in meat processing enables the emergence of a fat texture only at room temperature and without any thermal resistance or thermo-irreversibility. When cooking these processed foods, the animal fat content melts and the free water exudes. The ultimate texture holds only from the meat proteins.

Moreover, until now, food manufacturers are dependent on the intrinsic properties of the original components of the product, not easily replaceable or alterable, to define the nutritive values of their end-products. For example, the hamburger manufacturers can only partially control the fat content of their cooked beef patties sold to consumers. Normally a 100 g beef patty made from raw lean meat would contain, after cooking, more than 50 mg of cholesterol and 11 g of fat, of which, for half, are saturated fatty acids including about 0.4 g of trans fats. These trans fatty acids are scientifically recognized to bear adverse dietary values and effects.

To alleviate this constraint, it has been suggested to prepare similar foods by adding milk proteins from whole or skimmed milk, vegetable proteins isolates or vegetable (mostly hydrogenated) oil(s). The following patents suggest such additions:
U.S. Pat. No. 4,504,515 (1985)
U.S. Pat. No. 4,556,570 (1985)
U.S. Pat. No. 5,238,701 (1992)
U.S. Pat. No. 5,620,734 (1994)
U.S. Pat. No. 5,773,057 (1996)
CA 1 278 455 (1987)
CA 1 322 694 (1992)
CA 2 159 882 (1996)
CA 2 245 733 (1997)
CA 2 282 411 (1998)
CA 2 396 820 (2000)
CA 2 396 071 (2001)
CA 2 407 307 (2001)
CA 2 332 759 (2002)

Our invention is unique because of the simplicity of its ingredients and the easiness of its manufacturing procedure. A review of cited similar patents proves it.

Hohenester et al. U.S. Pat. No. 4,504,515 (1985) propose low-fat meat products and in particular sausages with high protein content employing frozen skimmed milk or whole milk to produce the desired low-calorie product. This patent suggests to eliminate all animal fats but does not recommend, and even forbids, to replace animal fats by other fats from a vegetable source. This simple patent does not anticipate the very peculiar manufacturing steps of our patent.

Brander et al. U.S. Pat. No. 4,556,570 (1985) suggest to manufacture an analog Vienna sausage by forming a dispersion of a fat released in an emulsion phase within a continuous matrix phase. The continuous matrix phase comprises a heat coagulable protein, locust bean or xanthan gum and a particulate unmodified waxy maize starch of branched-chain amylopectin polymers. This very complex invention refers to analog meats and does not suppose any particular textural property.

Dubanchet CA 1278455 (1987) and U.S. Pat. No. 5,238,701 (1992) sets up a delicatessen manufacturing process employing a vegetable fat to replace traditional animal fats. This vegetable fat is obtained by emulsifying hot vegetable oils in boiling water with milk proteins (not defined) to a temperature of at least 100 degree C. This fat replacer is stable at room temperature but not stable to large variations of temperature (from freezing to cooking). This stabilized emulsion can sustain refrigeration or freezing but melts when cooked and does not show any thermal resistance nor has any thermal irreversibility.

Wesdorp et Struik CA 1322694 (1993) patented an edible fat product made from crystallized fats blends. It is produced from a oil in water cold emulsion where the Theological properties depend on the size of the fat globules, their melting points and their degrees of crystallization. Contrary to our invention, this patent does not stabilize the texture and their blend cannot incorporate any other ingredients or additives without changing significantly the former rheological properties.

Reinl, Klaus et Pecher U.S. Pat. No. 5,620,736 (1994) prepared a cooled, spreadable foamed meat mousse. This product is made from hydrogenated vegetable oils blended to size-reduced meats. The mixture is then pasteurized, homogenized and cooled to a temperature in order to obtain a mousse base meat suitable for foaming with nitrogen or air. The spreadibility of the mousse depends on the amount and type of hydrogenated oils used and the amount of gas trapped in the mousse. Our Invention departs exactly from this type of use of hydrogenated oils to create texture.

Luzio et Tieleman CA 2159882 (1996) make a food composition (having a softening point of at least about 115° F.) composed of an emulsion and a chemically set gel. The emulsion is prepared from water and a fat but the chemically set gel is prepared from a carbohydrate (like pectins, alginates, kappa carragenates, carboxymethylcellulose, etc) and water. There exists at least a function having a chemical cationic link. This invention differs from ours by using carbohydrates polymers to create texture and by chemically modifying the composition of the gel through cationic binding. Our invention is only a physical process involving solubilized milk proteins.

Singh U.S. Pat. No. 5,773,057 (1996) discloses a low-fat, ground meat, fermented food products manufacturing procedure using a hydrolyzed milk protein gel, in a way similar to Dubanchet U.S. Pat. No. 5,238,701 (1992) but obtained by cooking the proteins at 77° C. and refrigerating the gel to 4° C. The resulting products cannot sustain freezing and nor does show any stabilized texture as our Invention.

Sassen CA 2245733 (1997) is also creating an edible composition from vegetable fats but where the texture comes from a blend of oils having a high saturation index and/or an esterification change of these oils. It is thus a chemical process where the alkids chains have necessarily more than 16-carbons length. Such composition is used only to produce margarine and other spreadable products without thermoresistance.

Fukui et Seki CA 2282411 (1998) have also created an oil:water emulsion using emulsifiers such as phospholipids or non-ionic surfactants where drugs are incorporated prior to their lyophilisation (or directly orally given in a specific therapy). This emulsion has no particular rheologic properties and is used only as a support to medications.

Yam CA 2346820 (2000) invented a method of solidifying liquid oils by mixing at least one liquid oil and at least one solid fat and by transforming the mixture into a homogeneous consistency. This preparation is characterized by being semi-solid and is not bearing any stabilized status of thermal resistance.

Eini et Tamarkin CA 2396071 (2001) thickened thixotropic oil compositions comprised of high proportions of long chain fatty acids with solidifying agents. This method is close to Sassen CA 2245733 and, thus, differs greatly from our Invention for the same reasons.

Abraham et al. CA 2407307 (2001) provide a high liquid oil margarine wherein the total fat content is made up of liquid oil and hard fat. Such product is made by blending 2 emulsions together. This invention is different from ours not only in the manufacturing process but also by the fact that no stabilization is provided. Moreover, the second emulsion comes from fractionated oils. Finally, the solid aspect comes from refrigeration and has no thermo-resistance.

Fehr et Baarda CA 2332759 (2002) invented a meat composite where flaked fats are added prior to maceration. It is the combination meat+fat which gives texture to the product, not providing any thermo-resistance.

As it can be seen from this review of related patents, no one combines our process and our ingredients to create, physically by blending, a product having the combined properties of thermo-resistance and thermo-irreversibility. Most patents refer to blends of oils which give semi-solid texture, rarely stabilized. Even to do so, blends are made with binding and/or emulsifying agents, chemically involved. Those using milk proteins use coagulation to create a complementary matrix to the desired emulsion added. In all cases, the process is not stable, never thermo-resistant and barely thermo-irreversible.

No other known patent combines only physical procedure to edible oils in order to give thermo-resistant and thermo-irreversible properties to an emulsion of pure (non fractionated) oil(s). The edibility of the product made according to our Invention is never subjected to alterations from fractionation, esterification or chemical reactions coming from adjuvant agents.

Against this background, there exists a need in the industry to improve properties of fat emultion composed of vegetable and/or animal fats and therefore to improve as well the properties of products made with this emulsion.

### OBJECTS OF THE INVENTION

An object of the invention is therefore to manufacture a texturized, thermo-resistant and thermo-irreversible gel composed of vegetable and/or animal fats by a new procedure

### USEFULNESS OF THE INVENTION

The culinary usages of the texturized, thermo-resistant and thermo-irreversible gel of vegetable and/or animal fat(s) made by the terms of the Invention are virtually unlimited but they all answer to the most strict requirements of nutrition for the advised consumer. Indeed, the Invention allows the food processors to substitute partially or totally the animal fats with a new and nutritious alternative in any food recipes. This alternative is tailored to the lipids profile choose by the processors and deemed by the consumers.

The nutritive benefits of vegetable oils are widely known and recognized by the scientific community. The contribution of the abundant presence of poly-unsaturated, unsaturated and essential fatty acids coming from these oils is more and more understood not only in terms of metabolic pathways but also in terms of well-beingness.

Our product, replacing the original animal fat, reduces the total fat intake of up to 50% of the initial amount.

The animal fats carry with them a series of components which are becoming more and more suspect to healthy consumers like cholesterol, saturated fatty acids, trans fats, etc. Their total or partial replacement by our texturized gel guide the consumers in more healthy choices and, at the same time, may benefit to the food processor by diminishing the manufacturing costs of the end-products.

The texturized, thermo-resistant and thermo-irreversible gel of vegetable and/or animal fat(s) produced according to the Invention is also dietetic choice because it is manufactured with a lipid profile selected according to the new nutrition requirements.

The texturized, thermo-resistant and thermo-irreversible gel of vegetable and/or animal fat(s) produced according to the Invention is offered in a vast series of textures to match its use in specific food formulations. It is, though, possible to distinguish between two major classes of texture: the soft and the firm.

Our Invention, the texturized, thermo-resistant and thermo-irreversible gel of vegetable and/or animal fat(s), can be compared to tofu, readily available in grocery stores. This variety of textures is important to suit the needs of the users in their food formulations. In fact, all the textures available are derived from the concentration and types of oils used in the manufacturing process along with the processing temperatures.

Practically, a processor willing to replace visible animal fat in hamburger patties would utilize our gel with a firm texture. Another processor who wishes to substitute dairy fats in coffee creams would preferably use our gel having a soft texture in its substitute.

The texturized, thermo-resistant and thermo-irreversible gel of vegetable and/or animal fat(s) produced according to the Invention is manufactured from edible vegetable fats. The choice of the oil(s) depends on the fatty acids profile sought. For example, our texturized, thermo-resistant and thermo-irreversible gel of vegetable and/or animal fat(s) produced according to the Invention made from canola oil will give the following lipids profile in comparison with other vegetable or animal fats:

| | SATURATED FATTY ACIDS | | | |
|---|---|---|---|---|
| | LINOLEIC | ALPHA-LINOLENIC | POLY- | MONO-UNSATURATED |
| LIPID SOURCE | ACID | ACID | UNSATURATED | ACIDS |
| CANOLA GEL | 7% | 21% | 11% | 61% |
| Safflower oil | 10% | 76% | Trace | 14% |
| Sunflower oil | 12% | 71% | 1% | 16% |
| Corn oil | 13% | 57% | 1% | 29% |
| Olive oil | 15% | 9% | 1% | 75% |
| Soybean oil | 15% | 54% | 8% | 23% |
| Peanut oil | 19% | 33% | Trace | 48% |
| Cottonseed oil | 27% | 54% | Trace | 19% |
| Lard | 43% | 9% | 1% | 47% |
| Beef tallow | 48% | 2% | 1% | 49% |
| Palm oil | 51% | 10% | Trace | 19% |
| Butterfat | 68% | 3% | 1% | 28% |
| Coconut oil | 91% | 2% | 0% | 7% |

* This table is adapted from www.canola.com <http://www.canola.com>

It is thus possible, for example, to create a new beef patty with less fat than normal by replacing the visible beef fat with our gel made according to the Invention but containing also ω-3 type fatty acids (alpha-linolenic acid), less cholesterol and almost the double amount of mono and poly-unsaturated fatty acids.

The originality of the Invention comes first from the manufacturing process already described leading to a new product: a texturized gel with thermo-resistant and thermo-irreversible properties never observed before. These properties hold against temperature variations from freezing to thawing until the complete cooking of the food where our Invention is incorporated.

The originality of the Invention comes also in the replacement power of the gel in the sense that the texturized product, which is solid, can be easily manipulated at temperatures ranging from −40° C. to 110° C. This fact allows the food processor to create new foods with new nutritional and organoleptic properties coming from all types of vegetable oils.

This double combination of originality is made from the selection of ingredients chemically compatible and mixed together through a physical process where each parameter has been carefully studied and where a very strict control is established during the mixing of each ingredient in order to insure the irreversible texturization of the product.

The mass balance of the ingredients is all conserved since no by-products are created during the process. The manufacturing process according to the Invention, when exploited in an industrial plant, will not create any measurable secondary pollution.

The advantages of the Invention are various and can be summarized under the following four topics:

A- Physical Advantages

The texturized, thermo-resistant and thermo-irreversible gel of vegetable and/or animal fat(s) made as per the Invention is a product easy to handle when replacing animal or vegetable fats present in foods regardless of the temperatures of execution. The gel keeps its texture at all processing temperatures of the food product produced. This is why it is aid to be a thermo-resistant gel from cooking to freezing. The use of this gel does not require any significant changes in manufacturing operations neither to the equipments used. The gel made as per the Invention can be incorporated in any food formulation just by very simple technical adjustments known to practical users into their processing sequence.

The texturized, thermo-resistant and thermo-irreversible gel of vegetable and/or animal fat(s) made as per the Invention is offered in blocks or sausages ranging from ½ to 20 kg, can be diced (0.5 to 2 cm size or greater) or presented in frozen flakes.

B- Dietetic Advantages

The dietetic and nutritious benefits of vegetable oils, especially when compared to fats from animal source, do not have to be explained. The total absence of cholesterol, the significant contribution of mono- and poly-unsaturated fats, the presence of ω-3 and ω-6 essential fatty acids (widely recognized for their anti-oxidant properties reducing the adverse effects of free radicals) give to the texturized, thermo-resistant and thermo-irreversible gel made as per the Invention new trumps in the hand of dieticians and consumers. It is now very difficult to gain from eating meat (carrying its train of saturated fats) and having sound and healthy food habits. The new texturized, therno-resistant and thermo-irreversible gel of vegetable and/or animal fat(s) manufactured as per the Invention eliminates this major constraint.

The texturized, thermo-resistant and thermo-irreversible gel of vegetable and/or animal fat(s) manufactured as per the Invention can, thus, be incorporated in food recipes at the same amount of the substituted fat. However, and it is a very significant difference, this gel usually contains only 44.6% of vegetable fat. Its addition to food reduces instantly the fat calorie content by more than 50%. The texturized, thermo-resistant and thermo-irreversible gel of vegetable and/or animal fat(s) manufactured as per the Invention creates immediate light foods.

C. Organoleptic Advantages

All organoleptic characteristics of foods made with the texturized, thermo-resistant and thermo-irreversible gel of vegetable and/or animal fat(s) manufactured as per the Invention are kept intact. We even notice a greater mouth feel and the disappearance of the bad taste resulting from oxydated animal rancid oils. The texturized, thermo-resistant and thermo-irreversible gel of vegetable and/or animal fat(s) manufactured as per the Invention does not create typical syneresis where free water is released by the product.

The texturized, thermo-resistant and thermo-irreversible gel of vegetable and/or animal fat(s) manufactured as per the Invention, when made from canola oil, does not give any flavour or odour to the product because of the blandness of the canola oil. Of course, other gels made from other vegetable oils may add a desired taste to the foods where they are incorporated, for example those made from olive oil.

D. Physico-Chemical Advantages

As stated earlier, the texturized, thermo-resistant and thermo-irreversible gel of vegetable and/or animal fat(s) manufactured as per the Invention is offered in two broad texture types: the soft and the firm gel.

The FIRM texturized, thermo-resistant and thermo-irreversible gel of vegetable and/or animal fat(s) manufactured as per the Invention is mostly used in food preparations where the fat is and should remain visible. Flaked or diced, the gel can be used in its frozen state. There exists no other non-hydrogenated vegetable fat which has this unique property of various usages.

The SOFT texturized, thermo-resistant and thermo-irreversible gel of vegetable and/or animal fat(s) manufactured as per the Invention can be used in liquid food preparations because of its rapid dispersibility into water or other emulsions. Its incorporation in very diluted form does support homogenisation which renders the product stable, without sedimentation, for long periods of time.

The stable and thermo-irreversible texture of the gel gives new advantages to food preparations from cooking to freezing. For example, in beef patties, the replacement of most of the visible beef fat will diminish greatly the cooking losses (mainly water and fats coming from the lean meat) compared to a standard patty. The following table compares two equivalent hamburger products:

| | REGULAR | | | | | PATTY WITH | | | | |
|---|---|---|---|---|---|---|---|---|---|---|
| | BEEF PATTY* | | | | | 20% GEL | | | | |
| | RAW | | COOKED | | | RAW | | COOKED | | |
| Weight | 100 | g | 68 | g | 32% | 79 | g | 68 | g | 14% |
| Calories | 221 | | 197 | | 11% | 142 | | 115 | | 19% |
| Choles- | 60 | mg | 47 | mg | 22% | 6 | mg | 3 | mg | 50% |
| terol | | | | | | | | | | |
| Fat | 15.7 | g | 12.1 | g | 23% | 8.6 | g | 7.2 | g | 16% |
| saturated | 6.7 | g | 5.1 | g | 24% | 0.5 | g | 0.4 | g | 14% |
| trans | 0.7 | g | 0.4 | g | 43% | Absence | | absence | | — |
| monoun- | 7.1 | g | 5.6 | g | 21% | 4.3 | g | 3.6 | g | 16% |
| saturated | | | | | | | | | | |
| polyun- | 0.4 | g | 0.3 | g | 25% | 2.2 | g | 1.9 | g | 14% |
| saturated | | | | | | | | | | |

| | | | | | | | | |
|---|---|---|---|---|---|---|---|---|
| Omega-3 | Absence | Absence | — | 0.8 | g | 0.7 | g | 12% |

*Regular patty figures come from www.beefinfo.org <http://www.beefinfo.org>

As seen in the previous table, a hamburger manufacturer will find a quadruple advantage to use our texturized, thermo-resistant and thermo-irreversible gel of vegetable and/or animal fat(s) manufactured as per the Invention.
First, the manufacturer will be able to offer a cooked patty, the same final weight as before, but with about 21% less weight in the raw patty (a net savings of meat);
A new marketing advantage arises by offering a lighter patty in fats, in calories, with less cholesterol and containing nutritious ω-3 fatty acids;
New benefits are obtained from less maintenance, emptying and cleaning fees of the grease traps by having more than half less of cooking losses ; and
The retention of water and fats while cooking will prevent formation of carcinogenous acrylamide from smokes when patties are BBQed on flame boards. To add the texturized, thermo-resistant and thermo-irreversible gel of vegetable and/or animal fat(s) manufactured as per the Invention to hamburger will eliminate completely this inconvenience and will render the cooking secure for the processor and the consumer.

The following examples illustrate the Invention while not limiting any claims of the Invention. All percentages are weight/weight except when explicitly said.

### EXAMPLE 1

A gel is made from a simple fat source of canola oil (labelled Component A) by mixing 44.6 kg of the said oil, heated at 90° C., with 8.9 kg of sodium caseinate using a Roto-solver agitator. Then, 44.6 kg of hot water, at the same temperature of the blend, are added as being Component B without any additive. Both Components A and B are mixed under strong agitation until a smooth plastic emulsion occurs. Then, 1.9 kg of table salt are carefully added and dissolved in the mixture in order to stabilize the texture. The resulting product is then frozen in 1 kg blocks.

### EXAMPLE 2

A similar preparation to Example #1 has been prepared but with peanut oil.

### EXAMPLE 3

A preparation similar to Example 1 has been made except that Component B was composed of 37.9 kg of water in which 6.7 of pureed beef hearts were blended. The resulting gel acquired a pink colour and bear more meat proteins coming from the beef harts.

### EXAMPLE 4

A simple SOFT gel made from 20 kg of canola oil (Component A) by heating it at 80° C. and to which 75.1 kg of water (Component B) are added at the same temperature. 9.5 kg of sodium caseinate were mixed previously with the water in a cooker-cutter. Then the two components are emulsified together by a 6 blades knife until a plastic emulsion is obtained. 2 kg of table salt are then mixed in until complete disappearance of salt granules. The resulting gel is cut in 1 kg blocks.

### EXAMPLE 5

A gel with a loose texture, made from olive oil (Component A) is made by mixing 10.0 kg of oil at 85° C. with 9.5 kg of hot calcium caseinate in a container where strong agitation is provided by a blade agitator. 85.1 kg of 85° C. water (Component B) are added to reach a plastic emulsion. Then 2.4 kg of calcium chloride are dissolved in the mixture. The resulting gel is frozen in 1 kg blocks for further usages.

### EXAMPLE 6

10 kg of the gel prepared in EXAMPLE 1 is mixed with 40 kg of beefmeat, removing all visible fat by knife. The frozen gel has been previously diced (0.4 cm sided) and is added, in a meat mixer, to the ground beef meat. When homogeneity is reached, the blended mixture is formed in 100 g patties and frozen until future use as hamburger patties.

### EXAMPLE 7

The EXAMPLE 3 gel is used similarly as in EXAMPLE 6.

### EXAMPLE 8

17.5 kg of the gel made according to EXAMPLE 1 is dissolved in 195 kg of skim milk, pasteurized and homogenized at 500 psi. The milk is then used to make cheddar according to regular practices. The resulting cheese has no cholesterol and bear ω-3 essential fatty acids.

### EXAMPLE 9

The milk produced in EXAMPLE 8 is rather homogenized at 2000 psi. and chilled to be drank as an ω-3 fluid milk without animal fat.

### EXAMPLE 10

100 liters of fluid milk containing 1% total fat is made by combining a partly skimmed milk (at 0.8% butter fat) with 460 g of our gel made from flaxseed oil. The mixture is subjected to a homogenizer at 2000 psi. and chilled. The resulting milk does contain 1.2 g of ω-3 per liter of milk.

### EXAMPLE 11

The milk produced in EXAMPLE 8 is used to make yoghurt.

### SUMMARY OF THE INVENTION

This Invention comes from an extensive research made at laboratory and industrial scales exploring the gelifying, thermo-resistant and thermo-irreversible properties of solubilized milk proteins. Most of these characteristics of solubilized milk proteins are not fully understood and these proteins little are used commercially, except for few very specific and widely known usages. The Invention describes a manufacturing process and a product which reveals the existence a new matrix created by the solubilized milk proteins in a oil:water emulsion and fixed by a dissolved salt. The most unique new property is that the resulting gel does not melt when cooked even after numerous cycles of freeze-thaw of the product. This is a true new phenomenon.

Thermo-resistance is measured by cooking the gel as any food. We see then that there is no loss of water or oil until the internal temperature reaches around more than 100° C. where, finally, water starts to boil off.

The thermo-irreversibility is measured by cooking the gel after at least one freeze-thaw cycle of the product. It can be seen that the external form of the gel is maintained without collapse or distorsion.

Although this new matrix use of solubilized milk proteins is not totally scientifically understood and explained, its use in cooking and food manufacturing is desirable and easily done.

More precisely, this invention describes a process to make a texturized gel of vegetable/animal fats which is thermo-resistant and thermo-irreversible. The use of this process or of its product (the gel) in food preparations ends the culinary and nutritive constraints described earlier. Now the advised consumers are offered new products which match their needs even through traditional foods.

Another significant advantage of our process is that, contrary to other processes, it will never affect the edibility of the oils used because there is no fractionation or chemical reactions (like esterification or hydrogenation) of the said oils.

The Invention is an alternative to the partial or complete replacement of animal fats in any recipe or food formulation. Thus the texturized, thermo-resistant and thermo-irreversible gel made from vegetable and/or animal fats according to the Invention can be used in any application where animal fat can be replace totally or partially.

Other applications of the Invention are done in pet foods, in vegetarian foods and are also possible in pharmacology as a support to fat-soluble drugs and medications.

The Invention is, in the first instance, a manufacturing process of a gel characterized by the followings:
a first hydrophobic component (identified as Component A) comprising at least one vegetable oil (generally a natural one) is heated; a second hydrophilic component (identified as Component B) comprising water is heated;
solubilized lactoproteins, having specific amphipathic and viscosity characteristics, are added to at least one of the components A and B, at the same temperature;
the components A and B including the solubilized lactoproteins are blended and then
emulsified until a smooth plastic texture is obtained; and
a specific salt is added, under agitation, to the former blend to fix the texture and to create the thermo-irreversibility of the gel ; and
the resulting product is conditioned to refrigeration and/or freezing.

The Invention is, in the second instance, the resulting product which is a texturized, thermo-resistant and thermo-irreversible gel made from vegetable and/or animal fats according the earlier described process.

Finally, in the third instance, the Invention covers various applications of the gel, among others:
as a complete or partial animal and/or vegetable fat(s) replacer in the following food domains : butchery, delicatessen, pastry, baking, sauces, cheese making, milk and beverages, etc.
as an animal fat(s) replacer in the pet food industry;
and as a vegetable fat(s) replacer in vegetarian foods.

The Invention and its numerous advantages will be understood when reading the following detailed but not limitative description referring to the enclosed drawing.

### BRIEF DESCRIPTION OF THE DRAWING

The attached drawing, labelled Drawing #1, illustrates by a schematic an example of the overall process according to the Invention.

### DETAILED DESCRIPTION OF THE INVENTION

As described previously and also illustrated in the attached drawing, the manufacturing process according to the Invention is done by following a succession of specific steps

The first and second steps are composed of preparing and heating the two components A and B. The third step is done by blending and emulsifying Component A in the presence of solubilized lacto-proteins. The fourth step consists of creating, by a controlled emulsification, a smooth but transitory plastic emulsion. The fifth step consists of fixing the thermo-irreversible characteristic of the gel by dissolving a salt in the matrix.

The first component A, said to be hydrophobic and amphipatic, is composed of a homogeneous blend of at least one vegetable oil with solubilized lacto-proteins. The addition and dissociation of the lacto-proteins to the component A is only a preferred procedure. It can also be added to the Component B.

The second Component B, said to be hydrophilic, is at least composed of water.

In practice, the heating of the components A and B is done at a temperature around or greater than 50° C. but preferably around 95° C. The increased temperatures will favour the firmness of the final gel.

The solubilized lacto-proteins are preferably caseinates salts like sodium caseinates. As indicated, the said proteins can be added, after pre-heating them as a preferable procedure, either to the component A or B. The lacto-proteins are added to the component which is kept at the same temperature as initially heated. Emulsification of the solid into the oil (or water phase) is primordial to obtain dissociation of the proteins. The amount is calculated as being greater or equal to 5% of the added masses of oil(s) and water present in the components A and B. This percentage can be, for example, around 10%.

When a firm thermo-resistant and thermo-irreversible gel is sought, the lacto-proteins used are of high viscosity. This viscosity can be, for example when measured by a Brookfield viscosimeter in a 15% solution at 20° C., greater than 1500 Pa·sec.

Preferably also, the components A and B are blended in a mass ratio close to equality but also comprised within the weight range from 70:30 to 20:80.

Again, preferably, the salt is added in a quantity equal or greater than 0.5% in weight of the total masses (oil(s), water and lacto-proteins in the components A and B. This percentage can be, for example, around 2%.

The addition of the said salt, preferably being sodium chloride, can be done in two steps: partly in the component B as a saturated salty water but as a peremptory solid in the emulsion.

As previously indicated, the component A is composed of one or more natural vegetable oil(s) selected among the generally available canola, safflower, sunflower, corn, olive, soybean, peanut, linseed, cottonseed, coconut, etc. oils. The component A can be composed of only one or a blend of these oils. However, other additives or fat-soluble ingredient(s) can also be added. This component A can also be made of only animal fat (s) or a blend of animal and vegetable fats (procedural adjustments are then needed).

The component B is composed of water. Sometimes, it can be also composed only of water. However, other additives or water-soluble ingredient(s) can be added or can be, composed of other hydrophilic liquids.

The additive(s), fat-soluble and/or water-soluble, which can be added to either Components A or B or both, can be selected amongst the intentional food additives such as:
coloring agents,
natural or artificial aromas,
olfactory agents or preparations,
aromatic preparations,
natural or artificial flavours (like, for example, spices and seasonings) including potentiators,
bio-active and/or nutraceutical ingredients,
micro-organisms (like bacteria, yeasts and molds)
whole or hydrolized proteins (including enzymes),
antimicrobial food additives,
antioxidants,
stabilizers and surface active agents,
acidulants,
sweeteners,
sequestrants agents,
gums and starches
vitamins and aminoacids,
food stabilizers,
organic minerals, chelated or not,
inorganic minerals,
food ingredients such as cereals, eggs, fruits and vegetables, meats, offal and giblets,
and medicines and drugs.

The resulting gel is conditioned in packaging sizes and types suitable for its end-use. A preferable procedure is to freeze the gel into its package until its usage.

1. A process for the production of a texturized, thermo-resistant and thermo-irreversible gel. This gel is made from an edible emulsion consisting of a continuous fat phase and an aqueous phase (which is dispersed as fine droplets in the fat phase) according to standard processing operations which are well within the knowledge of the skilled artisan but with the addition of two specific ingredients along with the following mandatory steps which are not normally sequenced in this order in standard processing operations:
heating, at a temperature equal to or above 60° C., a first hydrophobic component (hereafter labelled component A) comprising at least a vegetable or animal or marine oil, heating, at a temperature equal to or above 60° C., a second hydrophilic component (hereafter labelled component B) comprising at least water,
adding to component A and/or B a reticulum binder being solubilized lactoproteins characterized by their amphipathic properties and holding the temperature until full denaturation of the proteins,
blending the components A and B (comprising the denatured lactoproteins) and emulsifying the mixture until a smooth plastic texture is obtained,
and adding a salt to the emulsion to fix its texture and create the final thermo-resistance of the resulting gel.

2. (canceled)

3. The process according to claim #1 where sodium caseinates soluble in high viscosity mix are added as a reticulum binder and blended to component A (after its heating) until denaturation is achieved in order to create the reticulum conditions for the thermo-resistance and the thermo-irreversibility of the gel.

4. (canceled)

5. (canceled)

6. (canceled)

7. (canceled)

8. The process according to any of the claims #1 to #7 where the amount of the added solubilized high viscosity sodium caseinates is equal or greater than 5% of the sum of the oil(s) and water from components A and B (excluding any other additive(s) added).

9. The process according to claim #8 where the amount of the added solubilized high viscosity sodium caseinates is roughly equal to 10% of the sum of the oil(s) and water from components A and B(excluding any additive(s) added).

10. The process according to any of the claims #1 to #9 where the weights of the components A and B (excluding any additive(s) added) are mixed together in a ratio between 70:30 and 20:80 to obtain the desired smoothness of the gel.

11. The process according to any of the claims #1 to #10 where the amount of the added mandatory salt for thermo-resistance is sodium chloride and is equal to or greater than 0.5%, in weight, of the sum of the oil(s) and water from components A and B (excluding any additive(s) added); this amount depends on the degree of thermo-resistance needed for the gel.

12. The process according to claim #11 where the amount of the added salt is roughly equal to 2%, in weight, of the sum of the o.l(s) and water from components A and B (excluding any additive(s) added) for the maximal thermo-resistance of the gel.

13. (canceled)

14. The process according to any of the claims #1 to #13 where the addition of the salt is done in two steps meaning an addition in the component B as a saturated water of the said salt and an addition in the emulsion in the form of the solid salt.

15. (canceled)

16. (canceled)

17. The use of a gel having a thermo-resistant and a thermo-irreversible texture, made from at least a vegetable or an animal or a marine oil according to the process of any of the claims #1 to #16, as an animal fat replacer in applications related to butchery, delicatessen, pastry, bakery, cheese-making and dairy.

18. The use of a gel having a thermo-resistant and a thermo-irreversible texture, made from at least a vegetable or an animal or a marine oil according to the process of any of the claims #1 to #16, as an animal fat replacer in applications related to animal feed.

19. The use of a gel having a thermo-resistant and a thermo-irreversible texture, made from at least a vegetable or an animal or a marine oil according to the process of any of the claims #1 to #16, as an animal fat replace in applications related to vegetarian food.
